(19) United States
(12) Patent Application Publication
(10) Pub. No.: US 2003/0018535 A1
(43) Pub. Date: Jan. 23, 2003

(54) Method of marketing utilizing media and host computer to facililtate link between customer and retailer computers

(76) Inventor: Jeffrey Scott Eisenberg, Westlake Village, CA (US)

Correspondence Address: STETINA BRUNDA GARRED & BRUCKER, 75 ENTERPRISE, SUITE 250, ALISO VIEJO, CA, 92656, US

(21) Appl. No.: 09/909,401

(22) Filed: Jul. 19, 2001

(51) Int. Cl. G06F 17/60

(52) U.S. Cl. 705/26

(57) ABSTRACT

A method of marketing a product/service of a retailer to a customer utilizing media having instructions for use in a customer computer. The host computer receives an identification of a retailer computer by the retailer. A customer/host electronic communications link is established between the customer computer and the host computer through the use of the instructions. The host computer receives a retailer designator from the customer computer via the customer/host electronic communications link. The retailer designator is correlated to the retailer computer. A customer/retailer electronic communications link is facilitated between the customer computer and the retailer computer based upon the correlation of the retailer designator to the retailer computer for access by the customer to product/service data.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates generally to methods of marketing, and more particularly to a method of marketing a product/service of a retailer utilizing media and a host computer to facilitate an electronic link between a customer computer and a retailer computer.

The “electronic shopping” offered by businesses having an Internet presence is increasingly being viewed as a desirable alternative to the more traditional forms of shopping which typically necessitates a trip to a retail outlet or service provider. Those who shop online are often referred to as engaging in “e-commerce”. In this regard, an online retailer would typically maintain an e-commerce enabled web site on what is currently understood as the Internet. Such a web site would typically include an online catalog of goods or services advertised for sale. It is contemplated that such a web site would be configured to facilitate online transactions for such goods or services (e.g., able to receive orders, process payment by processing credit card debits, etc.).

The online retail industry is a competitive one. Online retailers employ numerous marketing methods to attract potential online customers to their web sites, and once there to encourage subsequent transactions. One such type of marketing method involves the distribution of media which may be provided to the customer for use with the customer's computer. The media may take the form of a CD-ROM for example. In this regard, the media may be physically mailed to the customer. In addition, a marketing plan may call for the media to be bundled or packaged with some product which is has already been purchased by the customer.

The media has instructions stored thereon for facilitating establishing an electronic communications link between the customer's computer and the online retailer's web site. In particular, the link would direct the customer's computer to connection with a specific web page or address. This presupposes that the customer's computer may be configured to connect with the retailer's web site, such as some form of Internet access. Thus, the instructions may take the form of software which interfaces with software associated with such Internet access. The media further has informational data stored thereon related to a product or service of the retailer sought to be marketed. In this regard, the retailer is contemplated to provide data of interest to the customer which would entice the customer to initiate use of the instructions for connection with the retailer's web site. As such, from the perspective of the retailer, the media serves the purpose of driving online “traffic” to the retailer's web site. In addition, to the extent that the media includes information which is useful to the customer, the retailer hope to generate goodwill with the customer towards the retailer. Such goodwill would potentially result in transactions with the customer, whether online or not.

A problem with the foregoing method of marketing is that the media is configured to establish an electronic link to a specific web page or address of the retailer's web site. Thus, once the media has been distributed, the media which directs online traffic to the retailer is static in nature (i.e., traffic always gets sent to the same location). In this regard, the retailer does not later have an option to direct customers to a more desirable location in the web site. Moreover, once the media is distributed, the retailer is effectively restricted to maintaining the specified web page and surrounding portion of the web site in a particular configuration. For example, the retailer would not be able to unrestrictedly redesign its web site and still receive the media generated online traffic.

It is therefore evident that there exists a need in the art for a more efficient method of marketing utilizing media for generating transactions with online retailers in comparison to the prior art methods.

### BRIEF SUMMARY OF THE INVENTION

In accordance with an embodiment of the present invention, there is provided a method of marketing a product/service of a retailer to a customer utilizing media for use in a customer computer. The media has instructions stored thereon for facilitating establishing a customer/host electronic communications link between the customer computer and a host computer and communicating a retailer designator related to the retailer via the customer/host electronic communications link. The media further has informational data stored thereon related to the product/service. The host computer initially receives an identification of a retailer computer by the retailer. The retailer computer has product/service data stored thereon related to the informational data. The product/service data corresponds to the product/service. A customer/host electronic communications link is established between the customer computer and the host computer through the use of the instructions in connection with access by the customer computer of the informational data. The host computer receives the retailer designator from the customer computer via the customer/host electronic communications link. The retailer designator is correlated to the retailer computer. Finally, a customer/retailer electronic communications link is facilitated between the customer computer and the retailer computer based upon the correlation of the retailer designator to the retailer computer for access by the customer to the product/service data.

According of additional aspects of the method of the present invention, the method may further include updating the identification of the retailer computer. Electronic access may be provided to the host computer by the retailer for electronically updating the identification of the retailer computer. The identification of a retailer computer by the retailer may be electronically received by the host computer.

In addition, a retailer page of the retailer computer may further be identified, and a customer/retailer electronic communications link may be facilitated between the customer computer and the retailer page based upon the correlation of the retailer designator to the retailer page for access by the customer to product/service data.

It is contemplated that the media may have instructions stored thereon for communicating a product/service designator related to information via the customer/host electronic communications link. In this regard, the method further provides that a product/service designator is identified associated with the retailer page, the product/service designator is received by the host computer from the customer computer via the established customer/host electronic communications link, the retailer designator and the product/service designator are correlated to the retailer page, and the customer/retailer electronic communications link is facilitated based upon the correlation of the retailer designator and the product/service to the retailer page.

Preferably, the media is physically portable and interfaces with the customer computer, and may take the form of a CD-ROM or a flash card. The customer/host electronic communications link may be established via a computer network. The customer/retailer electronic communications link may be established via a computer network. The number of times the customer/retailer communications link is established may be tracked.

In addition, the method may further include establishing a financial relationship between a host operator of the host computer and the retailer, wherein the retailer owes consideration to the host operator based upon the a number of times the customer/retailer electronic communications link is established. Further, the retailer may owe consideration to the host operator based upon sales transactions of the product/service to the customer by the retailer. In an alternate arrangement, the retailer itself may maintain the host computer.

Accordingly, the present invention represents a significant advance in the art.

### BRIEF DESCRIPTION OF THE DRAWINGS

These, as well as other features of the present invention, will become more apparent upon reference to the drawings wherein:

FIG. 1 is a symbolic relational diagram depicting a method of the present invention; and

FIG. 2 is a flow chart of the method of the present invention.

### DETAILED DESCRIPTION OF THE INVENTION

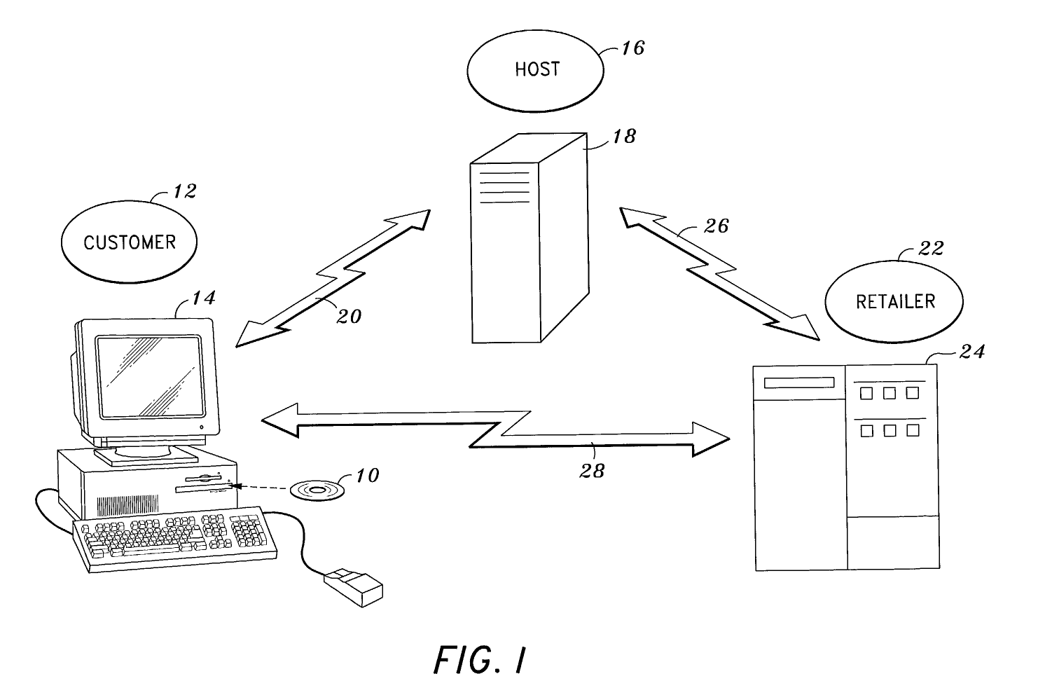

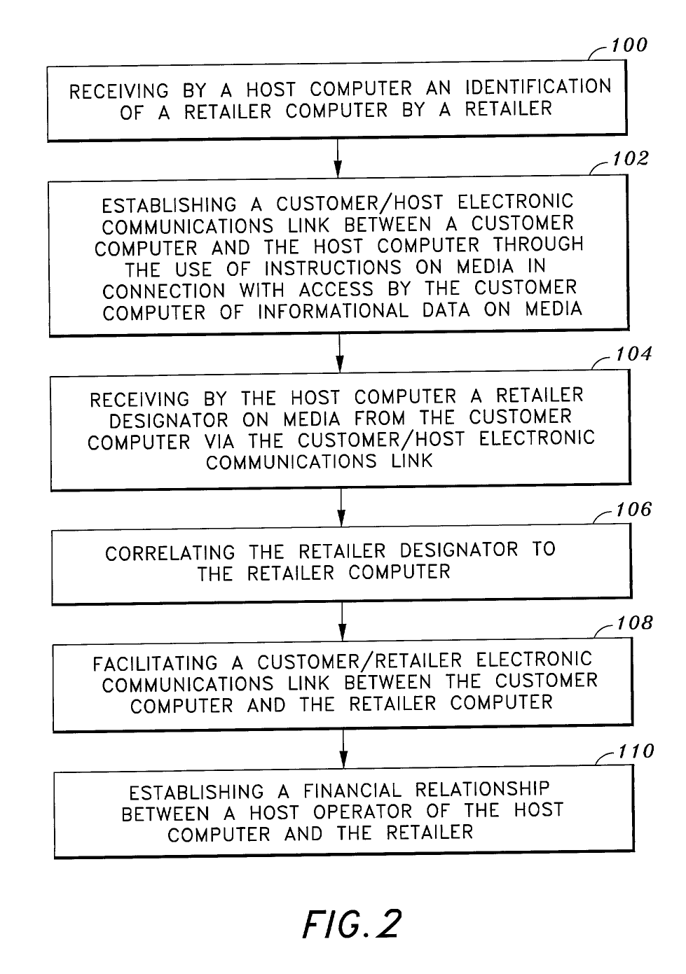

Referring now to the drawings wherein the showings are for purposes of illustrating a preferred embodiment of the present invention only, and not for purposes of limiting the same, FIGS. 1 and 2 illustrate a method of marketing according to the present invention.

Referring now to FIG. 1 there is depicted a symbolic relational diagram depicting media 10 utilized by a customer 12 in accordance with a method of the present invention, a flow chart of which is depicted in FIG. 2. As such, there is provided a method of marketing a product/service of a retailer 22 to the customer 12 utilizing the media 10 for use in a customer computer 14 of the customer 12. The media 10 has instructions stored thereon for facilitating establishing a customer/host electronic communications link 20 between the customer computer 14 and a host computer 18 and communicating a retailer designator related to the retailer 22 via the customer/host electronic communications link 20. The media 10 further has informational data stored thereon related to the product/service of the retailer 22.

The host computer 18 initially receives 100 an identification of a retailer computer 24 by the retailer 22. The retailer computer 24 has product/service data stored thereon related to the informational data. The product/service data corresponds to the product/service. The customer/host electronic communications link 20 is established 102 between the customer computer 14 and the host computer 18 through the use of the instructions in connection with access by the customer computer 14 of the informational data. The host computer 18 receives 104 the retailer designator from the customer computer 14 via the customer/host electronic communications link 20. The retailer designator is correlated 106 to the retailer computer 24. Finally, a customer/retailer electronic communications link 28 is facilitated 108 between the customer computer 14 and the retailer computer 24 based upon the correlation of the retailer designator to the retailer computer 24 for access by the customer 12 to the product/service data.

As used herein, the term retailer 22 refers to business entities, including individuals, having associated with it a product or service (generically referred to herein as product/service) for offering to a customer 12. In this regard, the term customer 12 includes not only those entities that transact business with the retailer 22 concerning the product/service, but also those that may potentially transact business with the retailer 22 or are targeted as such by the retailer 22. As used herein, the terms customer 12 and retailer 22 include both the singular and the plural.

As used herein the term product/service refers to any product or service offered by the retailer 22. The product/service may be a tangible good, such as automobile parts, tools, music CD's, pharmaceuticals, or health care products. The product/service may also take the form of software or data (such as a downloadable computer data file representative of audio or video data). The product/service may also be a service, such as related to database access, data listing or communications, or even something more traditional such as related to ordering or scheduling appointments (e.g., medical services, or hotel or travel reservations, for example).

The present method would typically be initiated by the retailer 22 procuring the services of a host 16 through the utilization of the media 10 and the host computer 18. As discussed in further detail below, such services are contemplated to aid the retailer 22 in marketing its products/services to its potential customers 12. The host 16 is associated with or otherwise maintains the host computer 18. Thus, the host 16 may have, as its own clients or customers, many retailers 22, each having its own respective retailer computers 24 and product/service offerings. The present method of marketing may be performed by the host 16, as well as the retailer 22 vis a vis procurement of such services from the host 16. Moreover, it is contemplated that the retailer 22 may functionally be the host 22. In this regard, the host computer 18 may be the same as the retailer computer 24 or at least the retailer 22 may control both the retailer computer 24 and the host computer 18.

The customer 12 is initially provided with the media 10. This may be effectuated by the host 16, the retailer 22 or some other entity. As used herein the media 10 refers to that which has associated with it the capacity to store data. Preferably, the media 10 is physically portable and interfaces with the customer computer 14, and may take the form of a CD-ROM, diskette, disk, or flash card, for example. However, the media 10 may exist remotely and may be a hard disk of a computer server for example. Thus, the data stored upon the media 10 may be accessed by the customer computer 14 via a downloading process which may occur via a computer network. The customer 12 even may thus initiate receipt of the media 10.

The distribution of the media 10 to the customer 12 may be effectuated in any manner. For example, the media 10 may be in the form of a CD-ROM, and may be physically mailed to the customer 12. The distribution of the media 10 may be a part of a mass mailing campaign as called for by a marketing plan of the retailer 22. In addition, the marketing plan may call for the media 10 to be bundled or packaged with some product which is has already been purchased by the customers 12. Further, the media 10 may be effectively distributed by sending e-mail advertisements to the customers 12 which would include an electronic link to the media 10 which may exist on the host computer 18 for example.

As mentioned above, the media 10 is utilized with the customer computer 14 of the customer 12. Thus, the media 10 and customer computer 14 must have the potential for compatibility. As used herein, the term computer includes any of those computing devices which are well known to one of ordinary skill in the art, including any device used to automatically apply logic. For example, such computing devices may include computers of all kinds such as personal computer, desktop computers, laptop computers, terminals, hand-held palm devices, personal digital assistants (PDAs), servers, portable telephones, etc. As such, the customer computer 14 may be a personal computer and the media 10 may take the form of a CD-ROM.

As mentioned above, the media 10 has instructions stored thereon for facilitating establishing the customer/host electronic communications link 20 between the customer computer 14 and a host computer 18. The customer/host electronic communications link 20, as well as a host/retailer electronic communications link 26 and the customer/retailer electronic communications link 28, may be effectuated via any of those methods which are well known to one of ordinary skill in the art which may utilize telephone, cable (Digital Subscriber Lines (DSL) and variations thereof, wire, optical, etc.), optical communications (including infrared), and wireless forms of communications, such as those based upon cellular, satellite, and radio frequency (RF), and other forms of electromagnetic wave based mediums. Further, the customer/host electronic communications link 20, as well as the host/retailer electronic communications link 26 and the customer/retailer electronic communications link 28, may be established via a computer network. While the computer network may be what is currently understood as the Internet, any other computer communication and/or network arrangements may also be utilized, such as local area networks (LANs), intranets, extranets, wide area networks (WANs), private networks, virtual private networks, dedicated circuits, integrated services digital networks (ISDNs), frame relay, etc. Thus, in the case where the computer network is the Internet, the host computer 18 may be hosted at a web address.

The instructions for facilitating establishing the customer/host electronic communications link 20 may take the form of a computer program or software which is configured to interface with communications software of the customer computer 14. The instructions would include programming to direct the linking of the customer computer 14 to the host computer 18. Thus, the instructions may direct the customer computer to a predetermined web page or address of the host computer 18. For example, the customer computer 14 may be configured to connect to the Internet via a Internet Service Provider (ISP). Thus, the instructions may take the form of software which interfaces with software associated with such Internet access. The instructions would first determine whether Internet access is currently available. If not, the instructions may initiate the access software of the customer computer 14 to establish Internet access. To the extent that the customer computer 14 is not initially configured to electronically communicate with an external computer, the instructions may further include software for the same. Once some form of access is established, then the instructions would direct a linking to the predetermined web page or address of the host computer 18. It is contemplated that the software and methods to effectuate the such linking may be chosen from those which are well known to one of ordinary skill in the art.

The media 10 further has informational data stored thereon related to the product/service of the retailer 22 sought to be marketed. In practice, the retailer 22 is contemplated to provide data of interest to the customer 12 which would entice the customer 12 to initiate use of the instructions for connection with the retailer computer 24 for exposure to the product/service data. In addition, to the extent that the media 10 includes information which is useful to the customer 12, the retailer 22 is presumed to hope to generate goodwill with the customer 12 towards the retailer 22. Such goodwill would potentially result in transactions with the customer 12, whether online or not. As such, from the perspective of the retailer 22, the media 10 serves the purpose of driving online “traffic” to the retailer computer 24, such as a web site of the retailer 22.

For example, the product/service of the retailer 22 may be a particular health care product, such as Vitamin A. The informational data could include a collection of content related to ailments and related cures or healthy living tips. In this context, there may be opportunities for recommendations or suggestions for the consumption of vitamins and in particular Vitamin A. Such informational data may be presented to the customer in a “browser” type interface which may include a graphical button type hypertext link. Such hypertext link may query the customer 12 as to whether the customer 12 desires to “buy now”. The instructions are configured such that “clicking” upon the “buy now” hypertext link would initiate the establishing 102 of the customer/host electronic communications link 20 with the host computer 18.

Importantly, the instructions are further configured to communicate a retailer designator related to the retailer 22 via the established customer/host electronic communications link 20. From the perspective of the host computer 18, the host computer 18 receives 104 such retailer designator. The host computer 18 utilizes such retailer designator for correlating 106 the retailer designator to the retailer computer 24. Thus, the host computer 18 is able to determine that the particular customer computer 14 to which is linked via the customer/host electronic communications link 20 is “traffic” that should be matched and routed to the retailer computer 24. In addition, a retailer page of the retailer computer 18 may further be identified and received 100 by the host computer 18. For example, the retailer page may be a specific web page within a web site of the retailer computer 24.

Thus, once the customer/host electronic communications link 20 is established 102, the customer/retailer electronic communications link 28 between the customer computer 14 and the retailer computer 24 is facilitated 108 by the host computer 18. In this regard, the host computer 18 effectively redirects the contact with the customer computer 14 from itself to the retailer computer 24. Once the customer computer 14 is electronically linked with the retailer computer 24, the retailer 22 may then expose the customer 12 to its product/service data. In the context of the above vitamin example, such product/service data may be ordering and pricing information regarding Vitamin A as offered for sale by the retailer 22.

As such, the host computer 18 may include a database which has a listing of a plurality of different retailer designators and associated retailer computers 24 or retailer pages to the extent the same is provided. The various retailer designators would respectively correspond to various retailers 22. In addition, the host computer 18 would have initially received 100 from each of the retailers 22 respective identifications of their various retailer computers 24. Thus, a particular retailer designator which originates from a particular media 10 is forwarded by the customer computer 14 to the host computer 18. Next, the host computer 18 correlates 106 the retailer designator to the retailer computer 24 such as by utilizing the database as a cross-referencing tool.

Having identified the correlated retailer computer 24, the host computer 18 facilitates 108 the customer/retailer electronic communications link 28 between the customer computer 14 and the retailer computer 24. For example, the host computer 18 could be configured to transmit to the customer computer 14, via the customer/host electronic communications link 20, the web address, location or retailer page information associated with the retailer computer 24. In response, a software browser of the customer computer 14 may then establish the customer/retailer electronic communications link 28. As shown in FIG. 1, the customer/retailer electronic communications link 28 is symbolic in nature, in that the customer/retailer electronic communications link 28 may be effectuated indirectly through a combination of the customer/host electronic communications link 20 and the host/retailer electronic communications link 26. In this regard, the host computer 18 may be configured to establish the host/retailer electronic communications link 26. For example, the customer/retailer electronic communications link 28 may be established through a “framing” technique as implemented by the host computer 18 which allows access by the customer computer 14 to the retailer computer 24 via the customer/host electronic communications link 20 without having the customer computer 14 to directly link to the retailer computer 24.

A product/service designator may also be identified associated with the retailer page. The product/service designator is received by the host computer 18 from the customer computer 14 via the established customer/host electronic communications link 20. The retailer designator and the product/service designator are correlated to the retailer page, and the customer/retailer electronic communications link 28 is facilitated by the host computer 18 based upon the correlation of the retailer designator and the product/service designator to the retailer page. In the context of the vitamin example, the retailer 22 may have multiple products/services, such as Vitamin A and Calcium supplements. The informational data could include a collection of content related to ailments and related cures or healthy living tips. There may be opportunities for recommendations or suggestions for the consumption of Vitamin A and Calcium supplements. At various locations in the informational data there may be presented to the customer 12 graphical button type hypertext links, each associated with a different product/service designator (e.g., associated with either Vitamin A or Calcium). Thus, depending upon which particular link is “clicked”, a different product/service designator may be transmitted to and additional received 104 by the host computer 18. The host computer 18 may be configured to correlate the retailer designator and the product/service designator to a retailer page as identified by the retailer 22.

Advantageously, the present invention is flexible in nature in that the method allows for the identification of the retailer computer 18 to be updated. Thus, according to additional aspects of the method of the present invention, the method may further include updating the identification of the retailer computer 18, and in particular, an updating of the identification of the retailer page. The retailer 22 may chose at some later time, that is desires to direct the customer 12 to a different retailer computer 24 or retailer page that initially configured with the host computer 18. Electronic access may be provided to the host computer 18 by the retailer 22 for electronically updating the identification of the retailer computer 24 via the host/retailer electronic communications link 26. Such updating may thus be done electronically with the identification of the retailer computer 24 by the retailer 22 may be electronically received by the host computer 18. Such ability to update effectively transforms the linking with the retailer computer 24 to be dynamic in nature. This is in contrast with prior art media arrangements which do not utilize a host computer 18 in favor of a direct linking to a retailer computer destination. This is because such prior art arrangements include programming to always point to the same location or destination. In comparison, the present method may be characterized as a dynamic redirection. Thus, for example, the retailer 22 may initialize the linking of the customer computers 14 to a particular retailer page having product/service data, such as pricing for Vitamin A. The retailer's marketing plan for some given time frame may dictate that it is preferable to drive such customer online traffic to a “specials” page, having information regarding discounted vitamins.

In addition, the method may further include establishing a financial relationship between a host operator or host 16 of the host computer 18 and the retailer 22. The relationship may provide that the retailer 22 owes consideration to the host 16 based upon the a number of times the customer/retailer electronic communications link 28 is established (i.e., a “click through” count). Such click through count may be calculated and monitored by the host computer 18, and may be useful in statistically analyzing the marketing activities. Further, in an alternate or hybrid arrangement, the retailer 22 may owe consideration to the host 16 based upon sales transactions of the product/service to the customer 12 by the retailer 22.

Additional modifications and improvements of the present invention may also be apparent to those of ordinary skill in the art. Thus, the particular combination of parts described and illustrated herein is intended to represent only one embodiment of the present invention, and is not intended to serve as limitations of alternative devices within the spirit and scope of the invention.

What is claimed is:

1. A method of marketing a product/service of a retailer to a customer utilizing media for use in a customer computer, the media having instructions stored thereon for facilitating establishing a customer/host electronic communications link between the customer computer and a host computer and communicating a retailer designator related to the retailer via the customer/host electronic communications link, the media having informational data stored thereon related to the product/service, the method comprising;
(a) receiving by the host computer an identification of a retailer computer by the retailer, the retailer computer having product/service data stored thereon related to the informational data, the product/service data corresponding to the product/service;
(b) establishing a customer/host electronic communications link between the customer computer and the host computer through the use of the instructions in connection with access by the customer computer of the informational data;
(c) receiving by the host computer the retailer designator from the customer computer via the customer/host electronic communications link;
(d) correlating the retailer designator to the retailer computer; and
(e) facilitating a customer/retailer electronic communications link between the customer computer and the retailer computer based upon the correlation of the retailer designator to the retailer computer for access by the customer to the product/service data.

2. The method of claim 1 further comprising updating the identification of the retailer computer.

3. The method of claim 2 further comprising providing electronic access to the host computer by the retailer for electronically updating the identification of the retailer computer.

4. The method of claim 1 wherein (a) further comprises electronically receiving by the host computer the identification of a retailer computer by the retailer.

5. The method of claim 1 wherein (a) further comprises identifying of a retailer page of the retailer computer, and (e) further comprises facilitating a customer/retailer electronic communications link between the customer computer and the retailer page based upon the correlation of the retailer designator to the retailer page for access by the customer to product/service data.

6. The method of claim 5 wherein the media has instructions stored thereon for communicating a product/service designator related to the informational data via the customer/host electronic communications link, (a) further comprises identifying a product/service designator associated with the retailer page, (c) further comprises receiving by the host computer the product/service designator from the customer computer via the established customer/host electronic communications link, (d) further comprises correlating the retailer designator and the product/service designator to the retailer page, and (e) further comprises facilitating the customer/retailer electronic communications link based upon the correlation of the retailer designator and the product/service to the retailer page.

7. The method of claim 1 wherein the media is a CD-ROM.

8. The method of claim 1 wherein the media is a flash card.

9. The method of claim 1 wherein the media is physically portable and interfaces with the customer computer.

10. The method of claim 1 wherein the customer/host electronic communications link is established via a computer network.

12. The method of claim 1 wherein the customer/retailer electronic communications link is established via a computer network.

13. The method of claim 1 further comprising:
(f) establishing a financial relationship between a host operator of the host computer and the retailer, wherein the retailer owes consideration to the host operator based upon a number of times the customer/retailer electronic communications link is established.

14. The method of claim 1 further comprising:
(f) establishing a financial relationship between a host operator of the host computer and the retailer, wherein the retailer owes consideration to the host operator based upon sales transactions of the product/service to the customer by the retailer.

15. The method of claim 1 wherein e) further comprises tracking a number of times the customer/retailer communications link is established.

16. The method of claim 1 wherein the retailer maintains the host computer.
